(19) United States
(12) Patent Application Publication
(10) Pub. No.: US 2026/0032617 A1
(43) Pub. Date: Jan. 29, 2026

(54) METHOD FOR REGISTERING DEVICE SENSING CAPABILITY, COMMUNICATION DEVICE AND STORAGE MEDIUM

(71) Applicant: BEIJING XIAOMI MOBILE SOFTWARE CO., LTD., Beijing (CN)

(72) Inventor: Jinhua WU, Beijing (CN)

(73) Assignee: BEIJING XIAOMI MOBILE SOFTWARE CO., LTD., Beijing (CN)

(21) Appl. No.: 19/101,293

(22) PCT Filed: Aug. 5, 2022
(86) PCT No.: PCT/CN2022/110711

§ 371 Date: Feb. 5, 2025

(51) Int. Cl. H04W 60/00; H04W 8/24

(52) U.S. Cl. CPC H04W 60/00; H04W 8/24

(57) ABSTRACT

A method for registering a device sensing capability is performed by a first user equipment (UE), and includes: sending sensing registration information to a first network function, in which the sensing registration information comprises a sensing capability identifier, and the sensing capability identifier identifies that the first UE supports a sensing function; and receiving a registration response message sent by the first network function, in which the registration response message indicates that the first UE completes a sensing registration.

### CROSS-REFERENCE TO RELATED APPLICATION

The present application is a U.S. National Stage of International Application No. PCT/CN2022/110711, filed on Aug. 5, 2022, the contents of all of which are incorporated herein by reference in their entireties for all purposes.

### BACKGROUND

The wireless sensing technology is widely used in scenarios where information about remote objects is obtained due to its feature of not requiring a physical contact. In the field of communication technology, a communication-based assisted sensing technology may further improve a performance of a communication system, such as a beam management and an interference mitigation. In addition, it may also be used in many application scenarios such as environmental monitoring, autonomous driving, and intrusion monitoring. A smart home is a typical application scenario of sensing technology. However, in the current mobile network communication system, there is no smart home sensing solution that relies on a mobile network.

### SUMMARY

The present disclosure relates to the field of mobile communication technology, and more particularly to a method and an apparatus for registering a device sensing capability, a method and an apparatus for applying device sensing, a communication device and a storage medium.

An embodiment of a first aspect of the present disclosure provides a method for registering a device sensing capability, which is performed by a first user equipment (UE), and includes: sending sensing registration information to a first network function, in which the sensing registration information includes a sensing capability identifier, and the sensing capability identifier identifies that the first UE supports a sensing function; and receiving a registration response message sent by the first network function, in which the registration response message indicates that the first UE completes a sensing registration.

An embodiment of a second aspect of the present disclosure provides a method for registering a device sensing capability, which is performed by a first network function, and includes: receiving sensing registration information sent by a first user equipment (UE), in which the sensing registration information includes a sensing capability identifier, and the sensing capability identifier identifies that the first UE supports a sensing function; and sending a registration response message to the first UE, in which the registration response message indicates that the first UE completes a sensing registration.

An embodiment of a third aspect of the present disclosure provides a method for registering a device sensing capability, and the method includes: a first user equipment (UE) sending sensing registration information to a first network function, in which the sensing registration information includes a sensing capability identifier, and the sensing capability identifier identifies that the first UE supports a sensing function; the first network function authenticating whether the first UE meets a registration requirement; and the first network function sending a registration response message to the first UE in a case that the first UE meets the registration requirement, in which the registration response message indicates that the first UE completes a sensing registration.

An embodiment of a fourth aspect of the present disclosure provides a method for applying device sensing, which is performed by a second user equipment (UE), and includes: sending a sensing event triggering request to a first network function, in which the sensing event triggering request instructs the first network function to notify a first UE to execute a sensing event in an area authorized by the second UE; and receiving a sensing event triggering response sent by the first network function, in which the sensing event triggering response notifies the second UE that the first UE confirms to execute the sensing event.

An embodiment of a fifth aspect of the present disclosure provides a method for applying device sensing, which is performed by a first network function, and includes: receiving a sensing event triggering request sent by a second user equipment (UE); sending the sensing event triggering request to a first UE, in which the sensing event triggering request notifies the first UE to execute a sensing event in an area authorized by the second UE; receiving a sensing event triggering response sent by the first UE; and sending the sensing event triggering response to the second UE, in which the sensing event triggering response notifies the second UE that the first UE confirms to execute the sensing event.

An embodiment of a sixth aspect of the present disclosure provides a method for applying device sensing, which is performed by a first user equipment (UE), and includes: receiving a sensing event triggering request sent by a first network function, in which the sensing event triggering request notifies the first UE to execute a sensing event in an area authorized by a second UE; and sending a sensing event triggering response to the first network function, in which the sensing event triggering response notifies the first network function that the first UE confirms to execute the sensing event.

An embodiment of a seventh aspect of the present disclosure provides a method for applying device sensing, and the method includes: a second user equipment (UE) sending a sensing event triggering request to a first network function, in which the sensing event triggering request instructs the first network function to notify a first UE to execute a sensing event in an area authorized by the second UE; the first network function receiving the sensing event triggering request and sending the sensing event triggering request to the first UE; the first UE sending a sensing event triggering response to the first network function, in which the sensing event triggering response notifies the second UE that the first UE confirms to execute the sensing event; and the first network function receiving the sensing event triggering response and sending the sensing event triggering response to the second UE.

An embodiment of an eighth aspect of the present disclosure provides an apparatus for registering a device sensing capability, which is applied to a first user equipment (UE), and includes a transceiving module. The transceiving module is configured to: send sensing registration information to a first network function, in which the sensing registration information includes a sensing capability identifier, and the sensing capability identifier identifies that the first UE supports a sensing function; and receive a registration response message sent by the first network function, in which the registration response message indicates that the first UE completes a sensing registration.

An embodiment of a ninth aspect of the present disclosure provides an apparatus for registering a device sensing capability, which is applied to a first network function, and includes a transceiving module. The transceiving module is configured to: receive sensing registration information sent by a first user equipment (UE), in which the sensing registration information includes a sensing capability identifier, and the sensing capability identifier identifies that the first UE supports a sensing function; and send a registration response message to the first UE, in which the registration response message indicates that the first UE completes a sensing registration.

An embodiment of a tenth aspect of the present disclosure provides an apparatus for applying device sensing, which is applied to a second user equipment (UE), and includes a transceiving module. The transceiving module is configured to: send a sensing event triggering request to a first network function, in which the sensing event triggering request instructs the first network function to notify a first UE to execute a sensing event in an area authorized by the second UE; and receive a sensing event triggering response sent by the first network function, in which the sensing event triggering response notifies the second UE that the first UE confirms to execute the sensing event.

An embodiment of an eleventh aspect of the present disclosure provides an apparatus for applying device sensing, which is applied to a first network function, and includes a transceiving module. The transceiving module is configured to: receive a sensing event triggering request sent by a second user equipment (UE); send the sensing event triggering request to a first UE, in which the sensing event triggering request is configured to notify the first UE to execute a sensing event in an area authorized by the second UE; receive a sensing event triggering response sent by the first UE; and send the sensing event triggering response to the second UE, in which the sensing event triggering response notifies the second UE that the first UE confirms to execute the sensing event.

An embodiment of a twelfth aspect of the present disclosure provides an apparatus for applying device sensing, which is applied to a first user equipment (UE), and includes a transceiving module. The transceiving module is configured to: receive a sensing event triggering request sent by a first network function, in which the sensing event triggering request notifies the first UE to execute a sensing event in an area authorized by a second UE; and send a sensing event triggering response to the first network function, in which the sensing event triggering response notifies the first network function that the first UE confirms to execute the sensing event.

An embodiment of a thirteenth aspect of the present disclosure provides a communication system, which includes a first user equipment (UE) and a first network function. The first UE sends sensing registration information to the first network function, the sensing registration information includes a sensing capability identifier, and the sensing capability identifier identifies that the first UE supports a sensing function. The first network function authenticates whether the first UE meets a registration requirement. The first network function sends a registration response message to the first UE in a case that the first UE meets the registration requirement, and the registration response message indicates that the first UE completes a sensing registration.

An embodiment of a fourteenth aspect of the present disclosure provides a communication system, which includes a first user equipment (UE), a first network function and a second UE. The second UE sends a sensing event triggering request to the first network function, and the sensing event triggering request instructs the first network function to notify the first UE to execute a sensing event in an area authorized by the second UE. The first network function receives the sensing event triggering request and sends the sensing event triggering request to the first UE. The first UE sends a sensing event triggering response to the first network function, and the sensing event triggering response notifies the second UE that the first UE confirms to execute the sensing event. The first network function receives the sensing event triggering response and sends the sensing event triggering response to the second UE.

An embodiment of a fifteenth aspect of the present disclosure provides a communication device, which includes: a transceiver; a memory; and a processor. The processor is connected to the transceiver and the memory respectively, and configured to control the transceiver to receive and transmit a wireless signal, and cause the method for registering the device sensing capability and the method for applying the device sensing according to the embodiments of the first aspect, second aspect, third aspect, fourth aspect, fifth aspect, sixth aspect and seventh aspect of the present disclosure to be implemented, by executing computer-executable instructions on the memory.

An embodiment of a sixteenth aspect of the present disclosure provides a computer storage medium, which stores computer-executable instructions that, after being executed by a processor, cause the method for registering the device sensing capability and the method for applying the device sensing according to the embodiments of the first aspect, second aspect, third aspect, fourth aspect, fifth aspect, sixth aspect and seventh aspect of the present disclosure to be implemented.

Additional aspects and advantages of present disclosure will be given in part in the following descriptions, become apparent in part from the following descriptions, or be learned from the practice of the present disclosure.

### BRIEF DESCRIPTION OF THE DRAWINGS

The above and/or additional aspects and advantages of embodiments of the present disclosure will become apparent and more readily appreciated from the following descriptions made with reference to the drawings.

FIG. 1 is a schematic flowchart of a method for registering a device sensing capability according to an embodiment of the present disclosure.

FIG. 2 is a schematic flowchart of a method for registering a device sensing capability according to an embodiment of the present disclosure.

FIG. 3 is a schematic flowchart of a method for registering a device sensing capability according to an embodiment of the present disclosure.

FIG. 4 is a schematic flowchart of a method for registering a device sensing capability according to an embodiment of the present disclosure.

FIG. 5 is a schematic flowchart of a method for registering a device sensing capability according to an embodiment of the present disclosure.

FIG. 6 is a schematic flowchart of a method for applying device sensing according to an embodiment of the present disclosure.

FIG. 7 is a schematic flowchart of a method for applying device sensing according to an embodiment of the present disclosure.

FIG. 8 is a schematic flowchart of a method for applying device sensing according to an embodiment of the present disclosure.

FIG. 9 is a schematic flowchart of a method for applying device sensing according to an embodiment of the present disclosure.

FIG. 10 is a schematic flowchart of a method for applying device sensing according to an embodiment of the present disclosure.

FIG. 11 is a schematic flowchart of a method for applying device sensing according to an embodiment of the present disclosure.

FIG. 12 is a schematic flowchart of a method for applying device sensing according to an embodiment of the present disclosure.

FIG. 13 is a block diagram of an apparatus for registering a device sensing capability according to an embodiment of the present disclosure.

FIG. 14 is a block diagram of an apparatus for registering a device sensing capability according to an embodiment of the present disclosure.

FIG. 15 is a block diagram of an apparatus for registering a device sensing capability according to an embodiment of the present disclosure.

FIG. 16 is a block diagram of an apparatus for registering a device sensing capability according to an embodiment of the present disclosure.

FIG. 17 is a block diagram of an apparatus for applying device sensing according to an embodiment of the present disclosure.

FIG. 18 is a block diagram of an apparatus for applying device sensing according to an embodiment of the present disclosure.

FIG. 19 is a block diagram of an apparatus for applying device sensing according to an embodiment of the present disclosure.

FIG. 20 is a block diagram of an apparatus for applying device sensing according to an embodiment of the present disclosure.

FIG. 21 is a block diagram of an apparatus for applying device sensing according to an embodiment of the present disclosure.

FIG. 22 is a block diagram of an apparatus for applying device sensing according to an embodiment of the present disclosure.

FIG. 23 is a schematic diagram of a communication device according to an embodiment of the present disclosure. and

FIG. 24 is a schematic diagram of a chip according to an embodiment of the present disclosure.

### DETAILED DESCRIPTION

Reference will be made in detail to embodiments of the present disclosure, examples of which are shown in the drawings. The same or similar elements or the elements having the same or similar functions are denoted by the same or similar reference numerals throughout the descriptions. The embodiments described herein with reference to drawings are illustrative, and used to explain the present disclosure. The embodiments shall not be construed to limit the present disclosure.

The wireless sensing technology aims to obtain information about a remote object and its features without a physical contact. Sensing data of the object and its surroundings may be analyzed to obtain valid information about a relevant object and its features. In the related art of wireless sensing technology, a radar (radio detection and ranging) is a widely used wireless sensing technology that uses radio waves to determine a distance (range), an angle or an instantaneous linear velocity of an object. As another example, a non-radio frequency (non-RF) sensor has also been used as a sensing technology in other fields, such as a time-of-flight (ToF) camera, an accelerometer, a gyroscope, and a lidar.

In the field of communication technology, a communication-based assisted sensing technology may further improve a performance of a communication system. In a communication system under the 3rd generation partnership project (3GPP) standard, such as a communication system based on the fifth generation (5G) mobile communication technology and its subsequent communication technology, integrated sensing and communication means that a sensing capability is provided by a same 5G new radio (NR) wireless communication system and infrastructure used for communication, and sensing information may come from RF and/or non-RF based sensors. Generally speaking, it may involve scenarios of communication-assisted sensing, such as scenarios where 5G communication systems provide sensing services or sensing-assisted communication. For example, the sensing information may be used to assist in a radio resource management, an interference mitigation, a beam management, a mobility, etc., in a case that sensing information related to a communication channel or environment is configured to improve communication services of the 5G system itself.

For example, communication-based assisted sensing may be used to improve the performance of the communication system in the following aspects:
sensing a location and a channel environment of a UE, narrowing a beam scanning range, and shortening a beam training time;
sensing a location, a speed, a motion trajectory and a channel environment of a user equipment (UE) to perform a beam prediction, reducing a cost of a beam measurement and a delay of a beam tracking; and
sensing a property and a channel environment of the UE to improve a performance of a channel estimation.

In addition, the communication-based assisted sensing technology may also be used in many application scenarios such as environmental monitoring, autonomous driving, and intrusion monitoring. In multiple market segments and vertical fields, 5G-based sensing services may provide convenient technical support for smart transportation, aviation, an enterprise, a smart city, a smart home, a factory, a consumer application, a human-computer interaction application (XR, including, but not limited to, a virtual reality (VR), an augmented reality (AR), a mixed reality (MR), an extended reality (ER), etc.) and a public sector.

Mobile operators may play an important role in providing customers with 5G-based integrated sensing and communication, including a management and a control of a 5G-based sensing business. A recently released 5G automotive association (5GAA) technical report (5GAA_White-Paper_C-V2X-Use-Cases-Volume-II.pdf) illustrates a role that operators may play in enhancing V2X-type services, particularly for infrastructure-assisted environmental sensing, infrastructure-based remote driving, high-definition map collection and sharing, and remote driving support.

For example, example use cases for communication-assisted sensing services include followings.
Real-time environmental monitoring: wireless signals are used to reconstruct environmental maps, further improving a positioning accuracy, and enabling environmental-related applications. For example, a series of real-time monitoring-related applications may be realized, including dynamic 3D maps, pedestrian flow statistic, intrusion detection, and traffic detection for assisted driving.
Autonomous vehicles/drones: autonomous vehicle/drone applications have common functional requirements. For example, the autonomous vehicles/drones should support detecting and avoiding (DAA) to avoid obstacles. Moreover, the autonomous vehicles/drones should have an ability to monitor path information, such as selecting routes, complying with traffic regulations, etc.
Air pollution monitoring: a quality of a received wireless signal shows different attenuation features with changes in an air humidity, an air particulate matter (PM) concentration, a carrier frequency, etc., and may be used for a weather or air quality detection.
Indoor healthcare and intrusion detection: a respiratory rate estimation, a respiratory depth estimation, an apnea detection, a vital signs monitoring of the elderly and an indoor intrusion detection may be realized.

It may be seen that the communication-assisted sensing technology has a good performance both at a technical level and at an application level.

Sensing in the smart home is a typical scenario of indoor/local sensing. Considering that people spend most of their time indoors, it is particularly important to improve a user experience in indoor scenes. Nowadays, more and more devices based on a mobile communication technology, such as wearable devices, sensors, smart phones, and customer premise equipment (CPE), are deployed in homes. In order to enjoy a more comfortable and convenient indoor life, various devices may be connected via wireless signals to construct a smart home platform.

In addition to communication purposes, the wireless signals may also be used for sensing, such as continuous monitoring of a home environment, for example, for the intrusion detection. However, in the current mobile network communication system, there is no smart home sensing solution that relies on a mobile network. In other words, for the smart home, how the mobile network provides sensing solutions has become an issue to be resolved.

To this end, the present disclosure proposes a method and an apparatus for registering a device sensing capability, a method and an apparatus for applying device sensing, provides a use case of a sensing technology based on the mobile communication technology in the smart home, realizes a sensing application of the smart home relying on the mobile network, and expands an application boundary of the mobile communication technology and the sensing technology.

The method and the apparatus for registering the device sensing capability, the method and the apparatus for applying the device sensing provided by the present disclosure will be introduced in detail below with reference to the accompanying drawings.

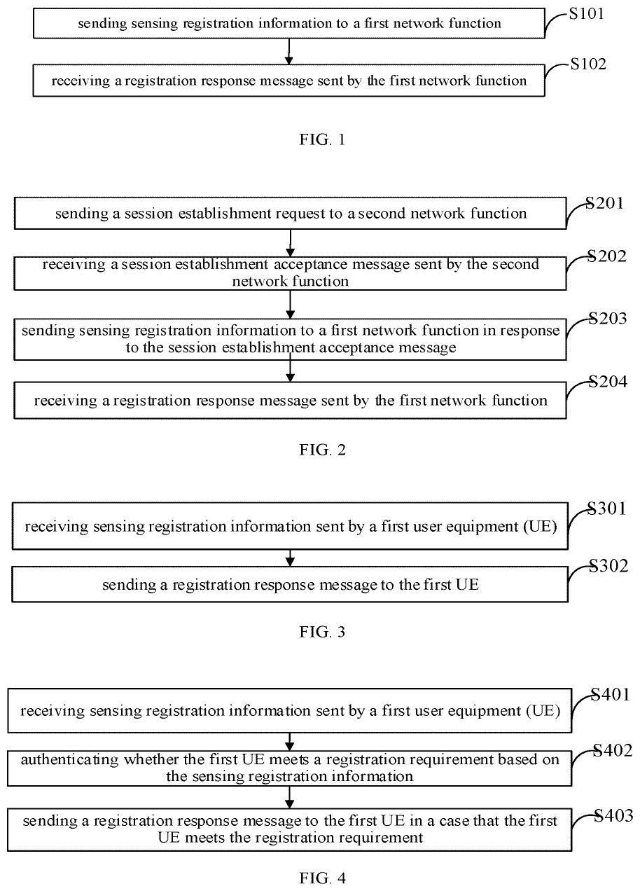

FIG. 1 shows a schematic flowchart of a method for registering a device sensing capability according to an embodiment of the present disclosure. As shown in FIG. 1, the method may be performed by a first user equipment (UE). In a smart home scenario, the first UE may be a smart home device. The method may include the following steps.

In step S101, sensing registration information is sent to a first network function.

The sensing registration information includes a sensing capability identifier, and the sensing capability identifier is configured to identify that the first UE supports a sensing function.

In an embodiment of the present disclosure, the first network function may be a network function deployed on a network side, specifically a sensing application function (SAF). In the present disclosure, the SAF is owned or trusted by an operator of a mobile network, for example, it may be deployed in an application program whose owner has established a trusted business and technical relationship with a mobile operator. The SAF may authenticate and authorize an execution of a sensing event between a UE and a sensing requester. In addition, the SAF may configure sensing parameters (such as a location, a range, a time, a radio frequency, etc.) in the UE, and an implementation of the SAF is not limited in the present disclosure.

It may be understood that the SAF may be a core network function, for example, as a type of core network element application functions (AFs), or it may be other network functions, which is not limited in the present disclosure.

For example, in a case that the SAF is deployed in a core network, for example, using a core network device as a carrier, it may communicate with the UE via an access network, and the first UE may send the sensing registration information to the SAF via the access network (RAN). In a case that the SAF is deployed in an access network, for example, using a base station as a carrier, it may communicate directly with the UE, and the first UE may directly send the sensing registration information to the SAF.

In the present disclosure, the UE sends the sensing registration information including the sensing capability identifier of the UE to the SAF. The sensing capability may indicate that the UE supports smart home sensing, including an intrusion detection, thereby realizing a registration of UE sensing in the SAF, so as to support an execution of a UE sensing event.

It may be understood that the first UE may send the sensing registration information by initiating a packet data unit (PDU) session process, which is not limited in the present disclosure.

In step S102, a registration response message sent by the first network function is received.

The registration response message is configured to indicate that the first UE completes a sensing registration.

In the present disclosure, after the SAF receives the sensing registration information sent by the first UE, since the information sent by the first UE carries the identifier indicating that the first UE supports the sensing function, the SAF may accept the registration of the first UE and respond to the first UE.

In summary, according to the method for registering the device sensing capability provided in the present disclosure, the first UE may send the sensing registration information including the sensing capability identifier to the first network function, the sensing capability identifier is configured to identify that the first UE supports the sensing function, the first UE receives the registration response message sent by the first network function, and the registration response message is configured to indicate that the first UE completes the sensing registration. The solution in the present disclosure provides a use case of a sensing technology based on a mobile communication technology in a smart home, realizes a sensing application of the smart home relying on the mobile network, and expands an application boundary of the mobile communication technology and the sensing technology.

FIG. 2 shows a schematic flowchart of a method for registering a device sensing capability according to an embodiment of the present disclosure. The method may be performed by a first UE. Based on the embodiment shown in FIG. 1, as shown in FIG. 2, the method may include the following steps.

In step S201, a session establishment request is sent to a second network function.

In an embodiment of the present disclosure, the second network function may be a network function deployed on a network side, specifically a core network function, including, but not limited to, an access and mobility management function (AMF). The first UE may register its sensing function to an SAF via the AMF.

Specifically, the first UE may initiate the session establishment request to a core network via an access network (RAN), and the session establishment request may be a packet data unit (PDU) session process establishment request.

For example, the first UE sends a registration request to an AMF network element via the access network (RAN), and the registration request includes parameters such as a registration type, a subscription concealed identifier (SUCI), a 5G-globally unique temporary UE identity (5G-GUTI), or a permanent equipment identifier (PEI). After the AMF network element authenticates and authorizes the UE, the AMF may send a registration acceptance response to the UE to complete a registration of the UE in the AMF. Secondly, the UE initiates a PDU session establishment process to the AMF network element. The PDU session establishment process initiated by the UE to the core network is not described in detail in this embodiment.

In step S202, a session establishment acceptance message sent by the second network function is received.

In an embodiment of the present disclosure, the AMF network element accepts the session establishment request of the first UE and feeds back a session establishment request acceptance message, such as a PDU session establishment acceptance response, to the first UE.

In step S203, sensing registration information is sent to a first network function in response to the session establishment acceptance message.

The sensing registration information includes a sensing capability identifier, and the sensing capability identifier is configured to identify that the first UE supports a sensing function.

For example, based on the received PDU session establishment acceptance response, the first UE may configure an IP address and send the sensing registration information to the SAF, and the sensing registration information at least includes an identifier configured to indicate that the first UE has the sensing function.

In an implementation of the present disclosure, the sensing registration information further includes: an identifier of the first UE.

For example, the sensing registration information includes an ID of the first UE, which may be an identifier that uniquely identifies the first UE, such as a subscriber permanent identifier (SUPI) or a generic public subscription identifier (GPSI), which is not limited in the present disclosure.

In addition, in an implementation of the present disclosure, the sensing registration information may further include an identifier of an area where the first UE is located.

For example, the sensing information includes an identifier corresponding to an area, where the first UE is located, and where a range is confirmable, such as a building (for example, an apartment, a residence or an office space, etc.), a public area (for example, a shopping mall, a park, etc.), etc. As an example for a smart home scenario, the identifier of the area may be a residential identifier (Home ID), and the Home ID may be a house number and a location of a house, or other numbers used to uniquely identify a house.

In step S204, a registration response message sent by the first network function is received.

The registration response message is configured to indicate that the first UE completes a sensing registration.

In the present disclosure, after the SAF receives the sensing registration information sent by the first UE, since the information sent by the first UE carries the identifier indicating that the first UE supports the sensing function, the SAF may accept the registration of the first UE and respond to the first UE.

In summary, according to the method for registering the device sensing capability provided in the present disclosure, the first UE may send the sensing registration information including the sensing capability identifier to the first network function via the session establishment process with the second network function, and the sensing capability identifier is configured to identify that the first UE supports the sensing function, the first UE receives the registration response message sent by the first network function, and the registration response message is configured to indicate that the first UE completes the sensing registration. The solution in the present disclosure provides a use case of a sensing technology based on a mobile communication technology in a smart home, realizes a sensing application of the smart home relying on a mobile network, and expands an application boundary of the mobile communication technology and the sensing technology.

FIG. 3 shows a schematic flowchart of a method for registering a device sensing capability according to an embodiment of the present disclosure. As shown in FIG. 3, the method may be performed by a first network function. In a smart home scenario, a first UE may be a network function deployed on a network side, specifically a sensing application function (SAF).

In the present disclosure, the SAF is owned or trusted by an operator of a mobile network, for example, it may be deployed in an application program whose owner has established a trusted business and technical relationship with a mobile operator. The SAF may authenticate and authorize an execution of a sensing event between a UE and a sensing requester. In addition, the SAF may configure sensing parameters (such as a location, a range, a time, a radio frequency, etc.) in the UE, and an implementation of the SAF is not limited in the present disclosure.

It may be understood that the SAF may be a core network function, for example, as a type of core network element application functions (AFs), or it may be other network functions, which is not limited in the present disclosure.

As shown in FIG. 3, the method may include the following steps.

In step S301, sensing registration information sent by a first user equipment (UE) is received.

The sensing registration information includes a sensing capability identifier, and the sensing capability identifier is configured to identify that the first UE supports a sensing function.

In an embodiment of the present disclosure, the first UE is a user terminal. Specifically, in the smart home scenario, the first UE may be a smart home device deployed at home.

In the present disclosure, the SAF receives the sensing registration information including the sensing capability identifier of the UE sent by the first UE. The sensing capability may indicate that the UE supports smart home sensing, including an intrusion detection, thereby realizing a registration of UE sensing in the SAF to support an execution of a UE sensing event.

In step S302, a registration response message is sent to the first UE.

The registration response message is configured to indicate that the first UE completes a sensing registration.

In the present disclosure, after the SAF receives the sensing registration information sent by the first UE, since the information sent by the first UE carries the identifier indicating that the first UE supports the sensing function, the SAF may accept the registration of the first UE and respond to the first UE.

In summary, according to the method for registering the device sensing capability provided in the present disclosure, the first network function may receive the sensing registration information including the sensing capability identifier sent by the first UE, the sensing capability identifier is configured to identify that the first UE supports the sensing function, the first network function sends the registration response message to the first UE, and the registration response message is configured to indicate that the first UE completes the sensing registration. The solution in the present disclosure provides a use case of a sensing technology based on a mobile communication technology in a smart home, realizes a sensing application of the smart home relying on the mobile network, and expands an application boundary of the mobile communication technology and the sensing technology.

FIG. 4 shows a schematic flowchart of a method for registering a device sensing capability according to an embodiment of the present disclosure. As shown in FIG. 4, the method may be performed by a first network function. Based on the embodiment of FIG. 3, as shown in FIG. 4, the method may include the following steps.

In step S401, sensing registration information sent by a first user equipment (UE) is received.

The above explanation about step S301 in the embodiment shown in FIG. 3 is also applicable to step S401, which will not be repeated here.

In step S402, it is authenticated whether the first UE meets a registration requirement based on the sensing registration information.

In an embodiment of the present disclosure, the sensing registration information further includes: an identifier of the first UE and an identifier of an area where the first UE is located.

A session management function (SMF) may determine whether an identifier of the first UE has a corresponding relationship with an identifier of an area where the first UE is located according to a pre-stored corresponding relationship table. The pre-stored corresponding relationship table includes a corresponding relationship between a UE identifier and an identifier of an area authorized for UE sensing. It is determined that the first UE meets the registration requirement in a case that the identifier of the first UE has the corresponding relationship with the identifier of the area where the first UE is located.

For example, the UE may be authenticated in a case that an SAF receives a registration request sent by the UE. For example, through information carried in the request sent by the UE, such as a UE ID, an SAF service platform saves a relationship between each UE and its corresponding key, and uses the corresponding key to determine whether to authorize the UE. For example, the UE provides the SAF with its own ID, for example, which may be a mobile phone number. The UE requests to control a home ID of Location_1 and executes sensing in an area corresponding to the home ID. The SAF stores a corresponding relationship between the UE ID and the home ID, so it may determine whether the UE ID may control the home ID, thereby authorizing or denying authorization to the UE.

It may be understood that the corresponding relationship between the home ID and the UE ID may be one-to-one, many-to-one, one-to-many or many-to-many, which is not limited in the present disclosure.

In step S403, a registration response message is sent to the first UE in a case that the first UE meets the registration requirement.

After the SAF authenticates the UE, the response message is sent to the UE in a case that the UE meets the registration requirement. The above explanation about step S302 in the embodiment shown in FIG. 3 is also applicable to step S403, which will not be repeated here.

In summary, according to the method for registering the device sensing capability provided in the present disclosure, the first network function may receive the sensing registration information including the sensing capability identifier sent by the first UE, the sensing capability identifier is configured to identify that the first UE supports the sensing function. The first network function may authenticate the UE, and send the registration response message to the first UE in a case that the authentication is passed, so as to complete the sensing registration. The solution in the present disclosure provides a use case of a sensing technology based on a mobile communication technology in a smart home, realizes a sensing application of the smart home relying on a mobile network, and expands an application boundary of the mobile communication technology and the sensing technology.

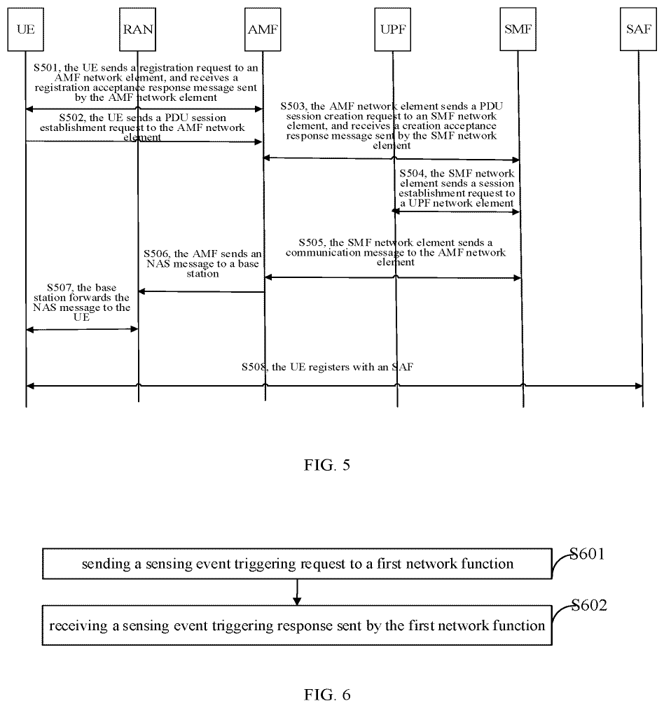

FIG. 5 shows a schematic flowchart of a method for registering a device sensing capability according to an embodiment of the present disclosure. As shown in FIG. 5, the schematic flowchart shows an interaction process between a first UE and a first network function and an interaction process between the first UE and a second network function, thereby completing a registration of the device sensing capability.

It may be understood that the “first” in the first UE in the present disclosure is configured to distinguish the first UE from a second UE. Since the second UE is not involved in this embodiment, the first UE is called a UE in this embodiment.

In the method, the first user equipment (UE) sends sensing registration information to a first network function, the sensing registration information includes a sensing capability identifier, and the sensing capability identifier is configured to identify that the first UE supports a sensing function; the first network function authenticates whether the first UE meets a registration requirement; and the first network function sends a registration response message to the first UE in a case that the first UE meets the registration requirement, and the registration response message is configured to indicate that the first UE completes a sensing registration.

Specifically, as shown in FIG. 5, the method may include the following steps.

In step S501, a UE sends a registration request to an AMF network element, and receives a registration acceptance response message sent by the AMF network element.

In an embodiment of the present disclosure, the UE sends the registration request to the AMF network element via an access network (RAN). The registration request includes parameters such as a registration type, a subscription concealed identifier (SUCI), a 5G-globally unique temporary UE identity (5G-GUTI), or a permanent equipment identifier (PEI). After the AMF network element authenticates and authorizes the UE, the AMF may send the registration acceptance response to the UE to complete the registration of the UE in the AMF.

In step S502, the UE sends a PDU session establishment request to the AMF network element.

Referring to the embodiments shown in FIG. 1 to FIG. 4, the UE may initiate a PDU session establishment process to the AMF network element, for example, by sending a non-access stratum (NAS) message including the PDU session establishment request in an N1 session management (SM) container to initiate the PDU session establishment process. For the AMF network element, it receives the PDU session establishment request from the UE.

In step S503, the AMF network element sends a PDU session creation request to an SMF network element, and receives a creation acceptance response message sent by the SMF network element.

Specifically, the AMF network element may select one session management function (SMF) network element and send the PDU session creation request (e.g., Nsmf_PDUSession_CreateSMContext request) to the SMF network element, which includes an indicator of the UE requesting an SAF internet protocol (IP) address and/or a point of control and observation (PCO) regarding an ability of the UE supporting sensing functions. After receiving the Nsmf_PDUSession_CreateSMContext Request, the SMF network element may respond to the AMF network element and send the creation acceptance response message to the AMF network element.

In step S504, the SMF network element sends a session establishment request to a user plane function (UPF) network element.

In this embodiment, the SMF network element may send the session establishment request (N4 Session Establishment Request) to the user plane function (UPF) network element, thereby establishing a new PDU session for the UE.

In step S505, the SMF network element sends a communication message to the AMF network element.

In this embodiment, the SMF network element sends a Namf_Communication_N1N2Message Transfer message to the AMF network element, which includes an IP address allocated to the UE.

In step S506, the AMF sends an NAS message to a base station.

In this embodiment, after receiving the Namf_Communication_N1N2Message Transfer message, the AMF sends an N2 PDU session request (NAS msg) to the RAN (gNB), which includes the IP address allocated to the UE.

In step S507, the base station forwards the NAS message to the UE.

In this embodiment, during an establishment of AN-Specific resources, the gNB forwards the NAS message (PDU Session Establishment Accept) provided in step S506 to the UE, which includes the IP address allocated to the UE.

In step S508, the UE registers with an SAF.

In the present disclosure, in the embodiments shown in FIG. 1 to FIG. 4, based on a received PDU session establishment acceptance, the UE configures the IP address and sends the sensing registration information to the SAF, which includes at least the sensing capability identifier of the UE, and may also include a UE ID and a Home ID. The Home ID may be a house number and a location of a house, or it may be a unique identifier of a house. The sensing capability may indicate that the UE supports smart home sensing, including an intrusion detection. The SAF accepts the registration and responds to the UE.

In summary, according to the method for registering the device sensing capability provided in the present disclosure, the UE may send the sensing registration information including the sensing capability identifier to the SAF via the session establishment process between the UE and a core network function, thereby completing the sensing registration of the UE with the SAF. The solution in the present disclosure provides a use case of a sensing technology based on a mobile communication technology in a smart home, realizes a sensing application of the smart home relying on a mobile network, and expands an application boundary of the mobile communication technology and the sensing technology.

FIG. 6 shows a schematic flowchart of a method for applying device sensing according to an embodiment of the present disclosure. As shown in FIG. 6, the method may be performed by a second user equipment (UE).

In an embodiment of the present disclosure, the second UE may be referred to a sensing requester, which may be a client or device of a user (for example, an owner) or a person (for example, the owner's family) authorized by the user in a smart home scenario.

As shown in FIG. 6, the method may include the following steps.

In step S601, a sensing event triggering request is sent to a first network function.

The sensing event triggering request is configured to instruct the first network function to notify a first UE to execute a sensing event in an area authorized by the second UE.

In an embodiment of the present disclosure, the first network function may be a network function deployed on a network side, specifically a sensing application function (SAF). In the present disclosure, the SAF is owned or trusted by an operator of a mobile network, for example, it may be deployed in an application program whose owner has established a trusted business and technical relationship with a mobile operator. The SAF may authenticate and authorize an execution of the sensing event between the UE and the sensing requester. In addition, the SAF may configure sensing parameters (such as a location, a range, a time, a radio frequency, etc.) in the UE, and an implementation of the SAF is not limited in the present disclosure.

It may be understood that the SAF may be a core network function, for example, as a type of core network element application functions (AFs), or it may be other network functions, which is not limited in the present disclosure.

For example, in a case that the SAF is deployed in a core network, for example, using a core network device as a carrier, the first UE may send sensing registration information to the SAF via an access network (RAN). In a case that the SAF is deployed in an access network, for example, using a base station as a carrier, the first UE may directly send the sensing registration information to the SAF.

In an embodiment of the present disclosure, the second UE may send a sensing event execution request to the SAF. In the smart home scenario, the owner may send a sensing request to the SAF to request a smart home device in the owner's home to execute the sensing event, such as an intrusion detection, via the mobile network.

In step S602, a sensing event triggering response sent by the first network function is received.

The sensing event triggering response is configured to notify the second UE that the first UE confirms to execute the sensing event.

In an embodiment of the present disclosure, in the smart home scenario, the first UE may be the smart home device. Specifically, it may be a smart home device with a sensing capability.

In an embodiment of the present disclosure, a 3GPP signal measured by the first UE may be affected due to activities of indoor objects or people. The first UE may collect and analyze sensing information such as a Doppler frequency shift, an amplitude change and a phase change of a communication signal to detect behaviors of the indoor objects or people. When a human intrusion is detected, the UE sends a sensing report together with an intrusion detection result, such as how many people broke into the home, to the SAF.

In an embodiment of the present disclosure, after receiving the sensing event triggering request sent by the second UE, the SAF responds to the second UE.

In summary, according to the method for applying the device sensing provided in the present disclosure, the second UE may send the sensing event triggering request to the first network function, and the sensing event triggering request is configured to instruct the first network function to notify the first UE to execute the sensing event in the area authorized by the second UE; and the second UE may receive the sensing event triggering response sent by the first network function, and the sensing event triggering response is configured to notify the second UE that the first UE confirms to execute the sensing event. The solution in the present disclosure provides a use case of a sensing technology based on a mobile communication technology in a smart home, realizes a sensing application of the smart home relying on the mobile network, and expands an application boundary of the mobile communication technology and the sensing technology.

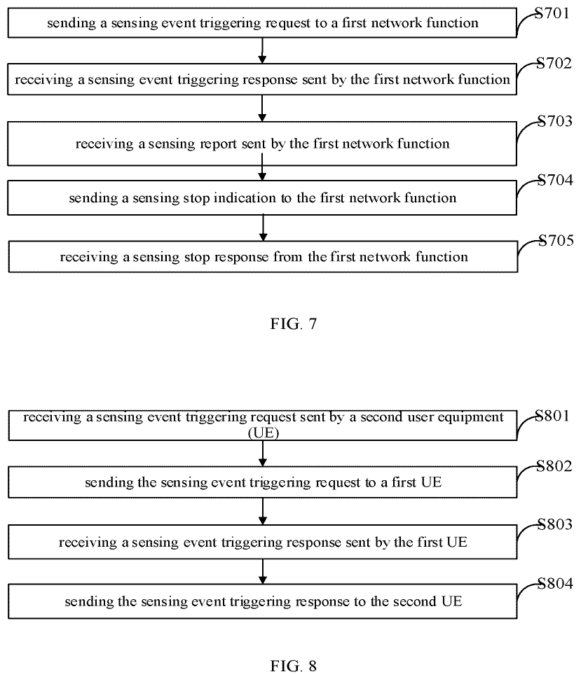

FIG. 7 shows a schematic flowchart of a method for applying device sensing according to an embodiment of the present disclosure. Based on the embodiment of FIG. 6, as shown in FIG. 7, the method may include the following steps.

In step S701, a sensing event triggering request is sent to a first network function.

The sensing event triggering request is configured to instruct a first network function to notify a first UE to execute a sensing event in an area authorized by a second UE.

It may be understood that, in some implementations of the present disclosure, the sensing event triggering request includes an identifier of the second UE, an identifier of the area authorized by the second UE to execute sensing, and an identifier of the sensing event.

For example, the second UE sends an ID of the second UE, an ID of the area authorized by the second UE (a Home ID of the user of the second UE), and an ID of the sensing event to an SAF. The sensing event may be an intrusion detection, and its corresponding ID may be, for example, Intrusion_Detection. Data included in the above sensing event triggering request may assist the SAF in sending a sensing triggering instruction to a UE with a sensing capability in an area corresponding to the Home ID, so that the UE with the sensing capability in the area executes the sensing event.

In step S702, a sensing event triggering response sent by the first network function is received.

The sensing event triggering response is configured to notify the second UE that the first UE confirms to execute the sensing event. In this step, the SAF confirms a start of sensing to a sensing requester.

The above explanations about steps S601 and S602 in the embodiment shown in FIG. 6 are also applicable to steps S701 and S702, which will not be repeated here.

In step S703, a sensing report sent by the first network function is received.

The sensing report is configured to report to the second UE a result of the first UE executing the sensing event in the area authorized by the second UE.

In an embodiment of the present disclosure, the above step S703 is an optional step. After the SAF notifies the UE with the sensing capability in the area to execute the sensing, the UE may report a result of executing the sensing event to the SAF, and the SAF may send the result to the second UE.

For example, after the SAF notifies the first UE with the sensing capability (e.g., a sweeper with the sensing capability) in the owner's home to perform the intrusion detection, a 3GPP signal measured by the first UE may be affected due to activities of indoor objects or people. The first UE may collect and analyze sensing information such as a Doppler frequency shift, an amplitude change and a phase change of a communication signal to detect behaviors of the indoor objects or people. When a human intrusion is detected, the UE sends the sensing report together with an intrusion detection result, such as how many people broke into the home, to the SAF. The SAF may forward the report to the second UE.

It may be understood that the detection result may be reported in real time or in response to changes, such as in a case that an intrusion is detected, which is not limited here in the present disclosure.

In step S704, a sensing stop indication is sent to the first network function.

In step S705, a sensing stop response is received from the first network function.

The sensing stop indication is configured to instruct the first network function to notify the first UE to stop executing the sensing event.

In the present disclosure, the second UE may instruct to stop an execution of the sensing event, and send the sensing stop indication to the SAF, and the SAF may feed back the sensing stop response to the second UE.

For example, in a case that the second UE enters its authorized area, for example in a case that the owner returns home, smart home sensing may be stopped by sending a sensing stop request to the SAF. The request includes the ID of the second UE and the ID (e.g., a home ID) of the area authorized by the second UE to execute sensing. After the SAF receives a confirmation message fed back by the first UE in response to the request, the SAF confirms a stop of sensing to the sensing requester.

In summary, according to the method for applying the device sensing provided in the present disclosure, the second UE may send the sensing event triggering request to the first network function, and receive the sensing event triggering response sent by the first network function, to start an execution of the sensing event, that is, to notify the second UE that the first UE confirms to execute the sensing event, and the second UE may receive the sensing report to obtain an execution result of the sensing event. In addition, the second UE may send a sensing event stop request to stop the execution of the sensing event. The solution in the present disclosure provides a use case of a sensing technology based on a mobile communication technology in a smart home, realizes a sensing application of the smart home relying on a mobile network, and expands an application boundary of the mobile communication technology and the sensing technology.

FIG. 8 shows a schematic flowchart of a method for applying device sensing according to an embodiment of the present disclosure. As shown in FIG. 8, the method may be performed by a first network function.

In an embodiment of the present disclosure, the first network function may be a network function deployed on a network side, specifically a sensing application function (SAF). In the present disclosure, the SAF is owned or trusted by an operator of a mobile network, for example, it may be deployed in an application program whose owner has established a trusted business and technical relationship with a mobile operator. The SAF may authenticate and authorize an execution of a sensing event between a UE and a sensing requester. In addition, the SAF may configure sensing parameters (such as a location, a range, a time, a radio frequency, etc.) in the UE, and an implementation of the SAF is not limited in the present disclosure.

It may be understood that the SAF may be a core network function, for example, as a type of core network element application functions (AFs), or it may be other network functions, which is not limited in the present disclosure. For example, in a case that the SAF is deployed in a core network, for example, using a core network device as a carrier, it communicates with the UE via an access network (RAN). In a case that the SAF is deployed in an access network, for example, using a base station as a carrier, it may communicate directly with the UE.

As shown in FIG. 8, the method may include the following steps.

In step S801, a sensing event triggering request sent by a second user equipment (UE) is received.

In an embodiment of the present disclosure, the second UE may be referred to a sensing requester, which may be a client or device of a user (for example, an owner) or a person (for example, the owner's family) authorized by a user in a smart home scenario.

In an embodiment of the present disclosure, the SAF may receive a sensing event execution request sent by the second UE. In the smart home scenario, the owner may send the sensing request to the SAF to request a smart home device in the owner's home to execute a sensing event, such as an intrusion detection, via the mobile network.

In step S802, the sensing event triggering request is sent to a first UE.

The sensing event triggering request is configured to notify the first UE to execute a sensing event in an area authorized by the second UE.

In an embodiment of the present disclosure, after receiving the sensing event triggering request, the SAF forwards it to the first UE.

The first UE has a sensing capability, and is a device in the area authorized by the second UE where the sensing event is executed. In the smart home scenario, the first UE may be the smart home device in the owner's home. It may be understood that a 3GPP signal measured by the first UE may be affected due to activities of indoor objects or people. The UE may collect and analyze sensing information such as a Doppler frequency shift, an amplitude change, and a phase change to detect behaviors of the indoor objects or people.

In step S803, a sensing event triggering response sent by the first UE is received.

In an embodiment of the present disclosure, after receiving the sensing event triggering request sent by the SAF, the first UE may confirm to the SAF that the sensing event is to be executed and send the sensing event triggering response to the SAF.

In step S804, the sensing event triggering response is sent to the second UE.

The sensing event triggering response is configured to notify the second UE that the first UE confirms to execute the sensing event.

In an embodiment of the present disclosure, the SAF feeds back the received sensing event triggering response sent by the first UE to the second UE, thereby notifying a start of sensing to the second UE.

In summary, according to the method for applying the device sensing provided in the present disclosure, the SAF may perform an instruction interaction between the second UE (sensing requester) and the first UE (sensing executor), thereby instructing the first UE to execute the sensing event in response to the request of the second UE, providing a use case of a sensing technology based on a mobile communication technology in a smart home, realizing a sensing application of the smart home relying on the mobile network, and expanding an application boundary of the mobile communication technology and the sensing technology.

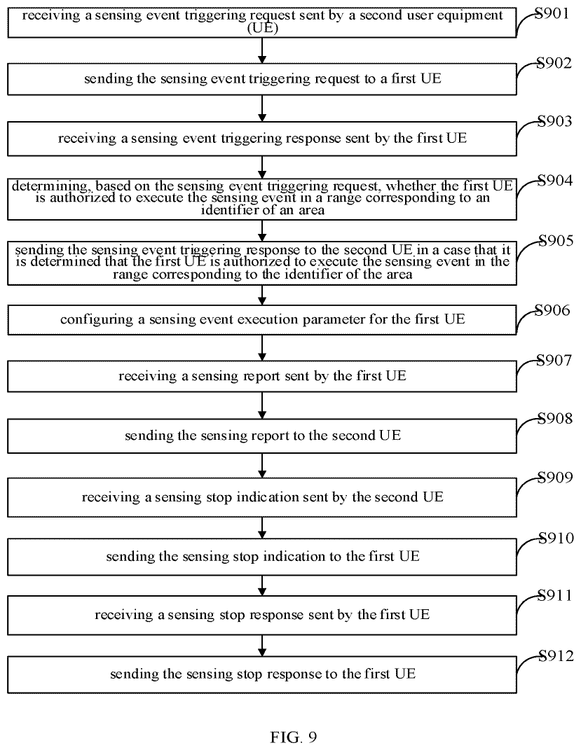

FIG. 9 shows a schematic flowchart of a method for applying device sensing according to an embodiment of the present disclosure. Based on the embodiment of FIG. 8, as shown in FIG. 9, the method may include the following steps.

In step S901, a sensing event triggering request sent by a second user equipment (UE) is received.

In step S902, the sensing event triggering request is sent to a first UE.

In S903, a sensing event triggering response sent by the first UE is received.

The above explanations about steps S801 to S803 in the embodiment shown in FIG. 8 are also applicable to steps S901 to S903, which will not be repeated here.

In step S904, based on the sensing event triggering request, it is determined whether the first UE is authorized to execute the sensing event in a range corresponding to an identifier of an area.

In an embodiment of the present disclosure, the sensing event triggering request includes an identifier of the second UE, an identifier of an area authorized by the second UE to execute sensing, and an identifier of the sensing event. In an implementation, before sending the sensing event triggering response to the second UE, an SAF may determine, based on the sense event triggering request, whether the first UE is authorized to execute the sensing event in the range corresponding to the identifier of the area.

In step S905, the sensing event triggering response is sent to the second UE in a case that it is determined that the first UE is authorized to execute the sensing event in the range corresponding to the identifier of the area.

In step S906, a sensing event execution parameter is configured for the first UE.

The sensing event execution parameter includes at least one of a sensing location, a sensing range, a sensing time and a radio frequency.

In the present disclosure, the SAF may authenticate and authorize the first UE and the second UE to execute sensing, and may configure sensing parameters (such as a location, a range, a time, a radio frequency, etc.) in the first UE. The above parameters are used by the first UE to collect and analyze sensing information such as a Doppler frequency shift, an amplitude change and a phase change in a certain range and at a certain detection frequency. As long as this function may be achieved, the present disclosure does not limit a type of the parameters.

In some embodiments, the method provided by the present disclosure further includes the following steps.

In step S907, a sensing report sent by the first UE is received.

In step S908, the sensing report is sent to the second UE. The sensing report is configured to report to the second UE a result of the first UE executing the sensing event in the area authorized by the second UE.

In an embodiment of the present disclosure, the above steps S907 to S908 are optional steps. After the SAF notifies a UE with a sensing capability in the area to execute sensing, the UE may report the result of executing the sensing event to the SAF, and the SAF may send the result to the second UE.

For example, after the SAF notifies the first UE with the sensing capability (e.g., a sweeper with the sensing capability) in the owner's home to perform the intrusion detection, a 3GPP signal measured by the first UE may be affected due to activities of indoor objects or people. The first UE may collect and analyze sensing information such as a Doppler frequency shift, an amplitude change and a phase change of a communication signal to detect behaviors of the indoor objects or people. When a human intrusion is detected, the UE sends the sensing report together with an intrusion detection result, such as how many people broke into the home, to the SAF. The SAF may forward the report to the second UE.

It may be understood that the detection result may be reported in real time or in response to changes, such as in a case that an intrusion is detected, which is not limited here in the present disclosure.

In step S909, a sensing stop indication sent by the second UE is received.

In step S910, the sensing stop indication is sent to the first UE. The sensing stop indication is configured to instruct the first UE to stop executing the sensing event.

In step S911, a sensing stop response sent by the first UE is received.

In step S912, the sensing stop response is sent to the second UE.

In the present disclosure, the second UE may instruct to stop an execution of the sensing event, and send the sensing stop indication to the SAF, and the SAF may feed back the sensing stop response to the second UE.

For example, in a case that the second UE enters its authorized area, for example in a case that the owner returns home, smart home sensing may be stopped by sending the sensing stop request to the SAF, and the SAF forwards the request to the first UE after receiving it. The request includes an ID of the second UE and an ID (e.g., a home ID) of the area authorized by the second UE to execute sensing. After the SAF receives a confirmation message fed back by the first UE in response to the request, the SAF forwards it to the second UE, that is, confirms a stop of sensing to the sensing requester.

In summary, according to the method for applying the device sensing provided in the present disclosure, the SAF may perform an instruction interaction between the second UE (sensing requester) and the first UE (sensing executor), thereby instructing the first UE to execute the sensing event in response to the request of the second UE, and may receive the sensing report to obtain an execution result of the sensing event and forward it to the second UE. In addition, the SAF may receive and forward a sensing event stop request to stop the execution of the sensing event. The solution in the present disclosure provides a use case of a sensing technology based on a mobile communication technology in a smart home, realizes a sensing application of the smart home relying on a mobile network, and expands an application boundary of the mobile communication technology and the sensing technology.

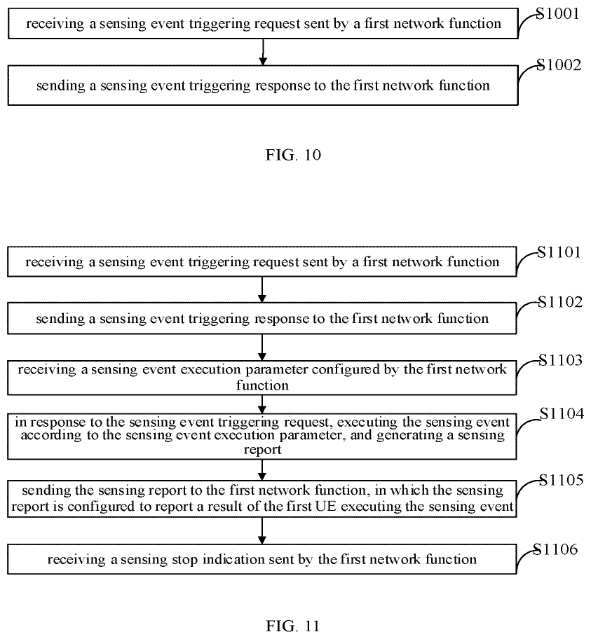

FIG. 10 shows a schematic flowchart of a method for applying device sensing according to an embodiment of the present disclosure. As shown in FIG. 10, the method may be performed by a first user equipment (UE). In a smart home scenario, the first UE may be a smart home device. Specifically, it may be a smart home device with a sensing capability.

In an embodiment of the present disclosure, a 3GPP signal measured by the first UE may be affected due to activities of indoor objects or people. The first UE may collect and analyze sensing information such as a Doppler frequency shift, an amplitude change and a phase change of a communication signal to detect behaviors of the indoor objects or people. When a human intrusion is detected, the UE sends a sensing report together with an intrusion detection result, such as how many people broke into the home, to an SAF.

As shown in FIG. 10, the method may include the following steps.

In step S1001, a sensing event triggering request sent by a first network function is received.

The sensing event triggering request is configured to notify the first UE to execute a sensing event in an area authorized by a second UE.

In an embodiment of the present disclosure, the first network function may be a network function deployed on a network side, specifically a sensing application function (SAF). In the present disclosure, the SAF is owned or trusted by an operator of a mobile network, for example, it may be deployed in an application program whose owner has established a trusted business and technical relationship with a mobile operator. The SAF may authenticate and authorize an execution of a sensing event between a UE and a sensing requester. In addition, the SAF may configure sensing parameters (such as a location, a range, a time, a radio frequency, etc.) in the UE, and an implementation of the SAF is not limited in the present disclosure.

It may be understood that the SAF may be a core network function, for example, as a type of core network element application functions (AFs), or it may be other network functions, which is not limited in the present disclosure.

In an embodiment of the present disclosure, the first UE may receive a sensing event execution request from the SAF. In the smart home scenario, the owner may send a sensing request to the SAF to request the smart home device in the owner's home to execute the sensing event, such as an intrusion detection, via the mobile network. In other words, the first UE may receive a request sent by the SAF and instructing the first UE to perform the intrusion detection.

In step S1002, a sensing event triggering response is sent to the first network function.

The sensing event triggering response is configured to notify the first network function that the first UE confirms to execute the sensing event.

In an embodiment of the present disclosure, in the smart home scenario, the first UE determines that it may start sensing and may send the sensing event triggering response to the SAF.

In summary, according to the method for applying the device sensing provided in the present disclosure, the first UE may receive the sensing event triggering request sent by the first network function, and send the sensing event triggering response to the first network function to implement an execution of the sensing event. The solution in the present disclosure provides a use case of a sensing technology based on a mobile communication technology in a smart home, realizes a sensing application of the smart home relying on the mobile network, and expands an application boundary of the mobile communication technology and the sensing technology.

FIG. 11 shows a schematic flowchart of a method for applying device sensing according to an embodiment of the present disclosure. Based on the embodiment shown in FIG. 10, as shown in FIG. 11, the method may include the following steps.

In step S1101, a sensing event triggering request sent by a first network function is received.

The sensing event triggering request is configured to notify the first UE to execute a sensing event in an area authorized by a second UE.

In step S1102, a sensing event triggering response is sent to the first network function.

The sensing event triggering response is configured to notify the first network function that the first UE confirms to execute the sensing event.

The above explanations about steps S1001 and S1002 in the embodiment shown in FIG. 10 are also applicable to steps S1101 and S1102, which will not be repeated here.

In some embodiments, the method further includes a following step.

In step S1103, a sensing event execution parameter configured by the first network function is received.

The sensing event execution parameter includes at least one of a sensing location, a sensing range, a sensing time and a radio frequency.

In the present disclosure, an SAF may authenticate and authorize the first UE and the second UE to execute sensing, and may configure sensing parameters (such as a location, a range, a time, a radio frequency, etc.) in the first UE. The above parameters are used by the first UE to collect and analyze sensing information such as a Doppler frequency shift, an amplitude change and a phase change in a certain range and at a certain detection frequency. As long as this function may be achieved, the present disclosure does not limit a type of the parameters.

In some embodiments, the method further includes the following steps.

In step S1104, in response to the sensing event triggering request, the sensing event is executed according to the sensing event execution parameter, and a sensing report is generated.

In step S1105, the sensing report is sent to the first network function. The sensing report is configured to report a result of the first UE executing the sensing event.

In an embodiment of the present disclosure, executing the sensing event includes: executing the sensing event by collecting and analyzing at least one of Doppler frequency shift data, amplitude change data, or phase change data of a communication signal sent by a network device.

For example, after the SAF notifies the first UE with the sensing capability (e.g., a sweeper with the sensing capability) in the owner's home to perform the intrusion detection, a 3GPP signal measured by the first UE may be affected due to activities of indoor objects or people. The first UE may collect and analyze sensing information such as a Doppler frequency shift, an amplitude change and a phase change of the communication signal to detect behaviors of the indoor objects or people. When a human intrusion is detected, the UE sends the sensing report together with an intrusion detection result, such as how many people broke into the home, to the SAF. The SAF may forward the report to the second UE.

It may be understood that the detection result may be reported in real time or in response to changes, such as in a case that an intrusion is detected, which is not limited here in the present disclosure.

In some embodiments, the method further includes a following step.

In step S1106, a sensing stop indication sent by the first network function is received.

A sensing stop response is sent to the first network function.

The sensing stop indication is configured to instruct the first network function to notify the first UE to stop executing the sensing event.

In the present disclosure, the second UE may instruct to stop an execution of the sensing event, and send the sensing stop indication to the SAF, and the SAF may feed back the sensing stop response to the second UE.

For example, in a case that the second UE enters its authorized area, for example in a case that the owner returns home, smart home sensing may be stopped by sending the sensing stop request to the SAF, and the SAF forwards the request to the first UE after receiving it. The request includes an ID of the second UE and an ID (e.g., a home ID) of the area authorized by the second UE to execute sensing. After the SAF receives a confirmation message fed back by the first UE in response to the request, the SAF forwards it to the second UE, that is, confirms a stop of sensing to the sensing requester.

In summary, according to the method for applying the device sensing provided in the present disclosure, the first UE (sensing executor) may, via the SAF, in response to the sensing request of the second UE (sensing requester), execute the sensing event and generate the sensing report, and report an execution result of the sensing event to the second UE via the SAF. In addition, the first UE may receive and respond to a sensing event stop request to stop the execution of the sensing event. The solution in the present disclosure provides a use case of a sensing technology based on a mobile communication technology in a smart home, realizes a sensing application of the smart home relying on a mobile network, and expands an application boundary of the mobile communication technology and the sensing technology.

FIG. 12 shows a schematic flowchart of a method for applying device sensing according to an embodiment of the present disclosure. As shown in FIG. 12, the schematic flowchart shows an interaction process among a first UE, a first network function, and a second UE, thereby completing an application of the device sensing.

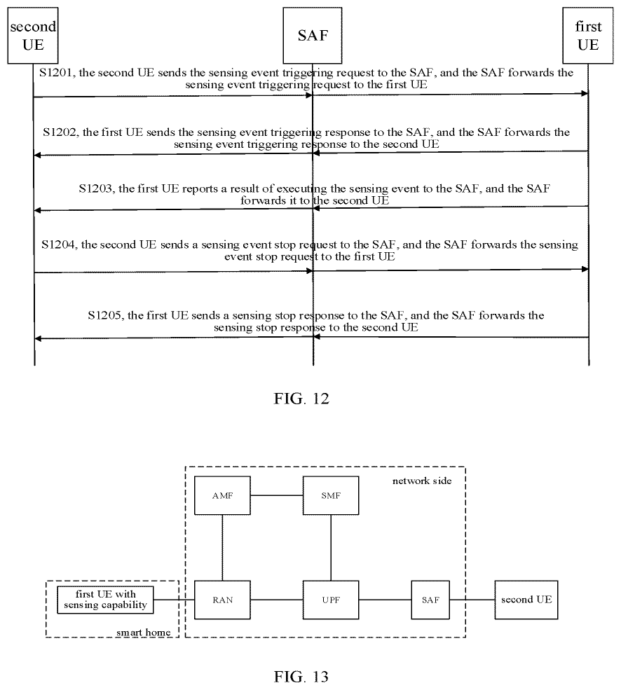

Before introducing a process of the method, an application architecture of the device sensing is described first. As shown in FIG. 13, a sensing technology application architecture diagram based on a mobile network is shown. It includes a first UE (sensing executor) with a sensing capability, a second UE (sensing requester) and network functions on a network side, including one or more core network functions and an SAF. For the introduction of each subject, reference may be made to the embodiments shown in FIG. 1 to FIG. 11, which will not be repeated here.

In the method, the second user equipment (UE) sends a sensing event triggering request to the first network function, and the sensing event triggering request is configured to instruct the first network function to notify the first UE to execute a sensing event in an area authorized by the second UE; the first network function receives the sensing event triggering request and sends it to the first UE; the first UE sends a sensing event triggering response to the first network function, and the sensing event triggering response is configured to notify the second UE that the first UE confirms to execute the sensing event; and the first network function receives the sensing event triggering response and sends it to the second UE.

This embodiment aims to illustrate a data and signaling interaction process of the SAF between the first UE (sensing executor) and the second UE (sensing requester). It may be understood that in a case that the SAF is deployed in a core network, its interaction with the UE needs to be carried out through an access network (RAN) (not shown in FIG. 12), which will not be repeated in this embodiment.

Specifically, as shown in FIG. 12, the method may include the following steps.

In step S1201, the second UE sends the sensing event triggering request to the SAF, and the SAF forwards the sensing event triggering request to the first UE.

The sensing event triggering request is configured to instruct the first network function to notify the first UE to execute the sensing event in the area authorized by the second UE.

In an embodiment of the present disclosure, the second UE (sensing requester) may be a client/device representing an owner or a person authorized by the owner. It may be understood that, in some implementations of the present disclosure, the sensing event triggering request includes an identifier of the second UE, an identifier of the area authorized by the second UE to execute sensing, and an identifier of the sensing event.

For example, the sensing requester sends an ID of the second UE, an ID (a Home ID of the user of the second UE) of the area authorized by the second UE, and an ID of the sensing event to the SAF. The sensing event may be an intrusion detection, and its corresponding ID may be, for example, Intrusion_Detection. Data included in the above sensing event triggering request may assist the SAF in sending a sensing triggering instruction to a UE with a sensing capability in an area corresponding to the Home ID, so that the UE with the sensing capability in the area executes the sensing event.

In step S1202, the first UE sends the sensing event triggering response to the SAF, and the SAF forwards the sensing event triggering response to the second UE.

In an embodiment of the present disclosure, the first UE confirms a start of sensing to the SAF. The SAF confirms the start of sensing to the sensing requester.

In step S1203, the first UE reports a result of executing the sensing event to the SAF, and the SAF forwards it to the second UE.

In an embodiment of the present disclosure, based on receiving a request for sensing initiation (intrusion detection), a UE (first UE) with a sensing capability in the user's home collects and analyzes sensing information such as a Doppler frequency shift, an amplitude change, and a phase change of a mobile communication signal to detect behaviors of indoors objects or people in the home. In a case that a human intrusion is detected, the first UE sends a sensing report together with an intrusion detection result, such as how many people broke into the home, to the SAF, and the SAF notifies the sensing requester.

In step S1204, the second UE sends a sensing event stop request to the SAF, and the SAF forwards the sensing event stop request to the first UE.

In an embodiment of the present disclosure, after the sensing requester returns home, smart home sensing may be stopped by sending a sensing stop request to the SAF and the first UE. For example, in a case that the second UE enters its authorized area, for example in a case that the owner returns home, the smart home sensing may be stopped by sending the sensing stop request to the SAF. The request includes the ID of the second UE and the ID (e.g., the home ID) of the area authorized by the second UE to execute sensing. After the SAF receives a confirmation message fed back by the first UE in response to the request, the SAF confirms a stop of sensing to the sensing requester.

In step S1205, the first UE sends a sensing stop response to the SAF, and the SAF forwards the sensing stop response to the second UE.

In an embodiment of the present disclosure, the first UE confirms the stop of sensing to the SAF. The SAF confirms the stop of sensing to the sensing requester.

In summary, according to the method for applying the device sensing provided in the present disclosure, the SAF may perform the instruction interaction between the second UE (sensing requester) and the first UE (sensing executor), thereby instructing the first UE to execute the sensing event in response to the request of the second UE, and may receive the sensing report to obtain the execution result of the sensing event and forward it to the second UE. In addition, the SAF may receive and forward the sensing event stop request to stop the execution of the sensing event. The solution in the present disclosure provides a use case of a sensing technology based on a mobile communication technology in a smart home, realizes a sensing application of the smart home relying on the mobile network, and expands an application boundary of the mobile communication technology and the sensing technology.

In the above embodiments provided in the present disclosure, the methods provided by embodiments of the present disclosure are introduced from the perspectives of the network side and the user equipment side, respectively. In order to implement the various functions in the methods provided by the above embodiments of the present disclosure, the network side and the user equipment side may include a hardware structure and a software module to implement the above functions in the form of the hardware structure, the software module, or the hardware structure plus the software module. Any of the above functions may be implemented in the form of the hardware structure, the software module, or the hardware structure plus the software module.

Corresponding to the method for registering the device sensing capability and the method for applying the device sensing provided by the above embodiments, the present disclosure also provides an apparatus for registering a device sensing capability and an apparatus for applying device sensing. Since the apparatus for registering the device sensing capability and the apparatus for the applying device sensing provided by embodiments of the present disclosure correspond to the method for registering the device sensing capability and the method for applying the device sensing provided by the above embodiments, the implementations of the method for registering the device sensing capability and the method for applying the device sensing are also applicable to the apparatus for registering the device sensing capability and the apparatus for the applying device sensing provided by the embodiments, which will not be described in detail in the embodiments.

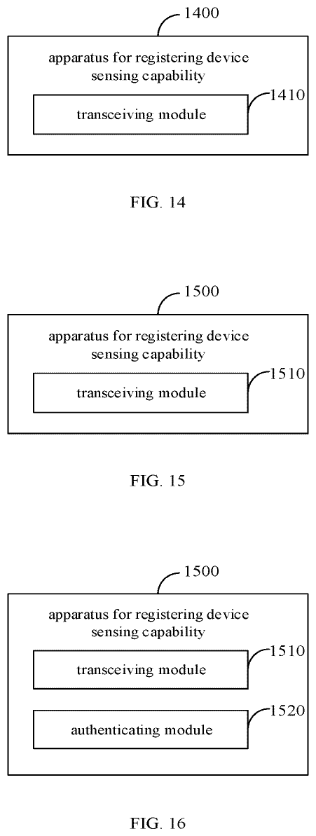

FIG. 14 is a block diagram of an apparatus 1400 for registering a device sensing capability according to an embodiment of the present disclosure. The apparatus 1400 for registering the device sensing capability may be used for a first user equipment (UE). The apparatus 1400 includes a transceiving module 1410, and the transceiving module 1410 is configured to: send sensing registration information to a first network function, in which the sensing registration information includes a sensing capability identifier, and the sensing capability identifier is configured to identify that the first UE supports a sensing function; and receive a registration response message sent by the first network function, in which the registration response message is configured to indicate that the first UE completes a sensing registration.

According to the apparatus for registering the device sensing capability provided in the present disclosure, the first UE may send the sensing registration information including the sensing capability identifier to the first network function, the sensing capability identifier is configured to identify that the first UE supports the sensing function, the first UE receives the registration response message sent by the first network function, and the registration response message is configured to indicate that the first UE completes the sensing registration. The solution in the present disclosure provides a use case of a sensing technology based on a mobile communication technology in a smart home, realizes a sensing application of the smart home relying on a mobile network, and expands an application boundary of the mobile communication technology and the sensing technology.

In some embodiments of the present disclosure, the transceiving module 1410 is further configured to: send a session establishment request to a second network function; receive a session establishment acceptance message sent by the second network function; and send the sensing registration information to the first network function in response to the session establishment acceptance message.

In some embodiments of the present disclosure, the sensing registration information further includes: an identifier of the first UE and an identifier of an area where the first UE is located.

In summary, according to the apparatus for registering the device sensing capability provided in the present disclosure, the first UE may send the sensing registration information including the sensing capability identifier to the first network function via the session establishment process with the second network function, the sensing capability identifier is configured to identify that the first UE supports the sensing function, the first UE receives the registration response message sent by the first network function, and the registration response message is configured to indicate that the first UE completes the sensing registration. The solution in the present disclosure provides the use case of the sensing technology based on the mobile communication technology in the smart home, realizes the sensing application of the smart home relying on the mobile network, and expands the application boundary of the mobile communication technology and the sensing technology.

FIG. 15 is a block diagram of an apparatus 1500 for registering a device sensing capability according to an embodiment of the present disclosure. The apparatus 1500 for registering the device sensing capability may be used for a first network function. The apparatus 1500 includes a transceiving module 1510. The transceiving module 1510 is configured to: receive sensing registration information sent by a first user equipment (UE), in which the sensing registration information includes a sensing capability identifier, and the sensing capability identifier is configured to identify that the first UE supports a sensing function; and send a registration response message to the first UE, in which the registration response message is configured to indicate that the first UE completes a sensing registration.

In summary, according to the apparatus for registering the device sensing capability provided in the present disclosure, the first network function may receive the sensing registration information including the sensing capability identifier sent by the first UE, the sensing capability identifier is configured to identify that the first UE supports the sensing function, the first network function sends the registration response message to the first UE, and the registration response message is configured to indicate that the first UE completes the sensing registration. The solution in the present disclosure provides a use case of a sensing technology based on a mobile communication technology in a smart home, realizes a sensing application of the smart home relying on a mobile network, and expands an application boundary of the mobile communication technology and the sensing technology.

In some embodiments of the present disclosure, based on the embodiment shown in FIG. 15, as shown in FIG. 16, the apparatus 1500 further includes an authenticating module 1520 configured to authenticate whether the first UE meets a registration requirement based on the sensing registration information.

In some embodiments of the present disclosure, the sensing registration information further includes: an identifier of the first UE and an identifier of an area where the first UE is located. The authenticating module 1520 is configured to: determine, according to a pre-stored corresponding relationship table, whether the identifier of the first UE has a corresponding relationship with the identifier of the area where the first UE is located, in which the pre-stored corresponding relationship table includes a corresponding relationship between a UE identifier and an identifier of an area authorized for UE sensing; and determine that the first UE meets the registration requirement in a case that the identifier of the first UE has the corresponding relationship with the identifier of the area where the first UE is located.

In summary, according to the apparatus for registering the device sensing capability provided in the present disclosure, the first network function may receive the sensing registration information including the sensing capability identifier sent by the first UE, and the sensing capability identifier is configured to identify that the first UE supports the sensing function. The first network function may authenticate the UE, and send the registration response message to the first UE in a case that the authentication is passed, so as to complete the sensing registration. The solution in the present disclosure provides a use case of a sensing technology based on a mobile communication technology in a smart home, realizes a sensing application of the smart home relying on a mobile network, and expands an application boundary of the mobile communication technology and the sensing technology.

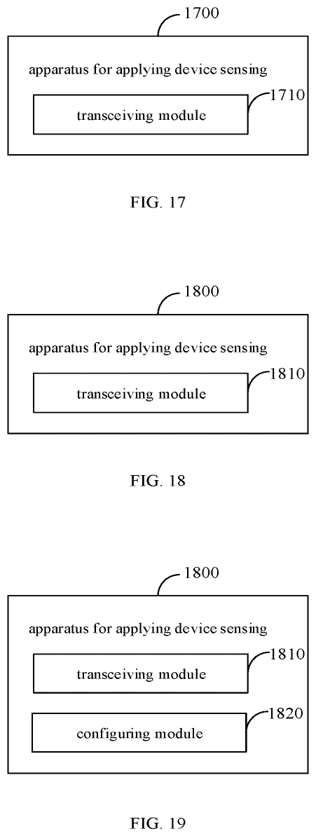

FIG. 17 is a block diagram of an apparatus 1700 for applying device sensing according to an embodiment of the present disclosure. The apparatus 1700 for applying the device sensing may be used for a second UE. The apparatus 1700 includes a transceiving module 1710. The transceiving module 1710 is configured to: send a sensing event triggering request to a first network function, in which the sensing event triggering request is configured to instruct the first network function to notify a first UE to execute a sensing event in an area authorized by the second UE; and receive a sensing event triggering response sent by the first network function, in which the sensing event triggering response is configured to notify the second UE that the first UE confirms to execute the sensing event.

In summary, according to the apparatus for applying the device sensing capability provided in the present disclosure, the second UE may send the sensing event triggering request to the first network function, and the sensing event triggering request is configured to instruct the first network function to notify the first UE to execute the sensing event in the area authorized by the second UE; and the second UE may receive the sensing event triggering response sent by the first network function, and the sensing event triggering response is configured to notify the second UE that the first UE confirms to execute the sensing event. The solution in the present disclosure provides a use case of a sensing technology based on a mobile communication technology in a smart home, realizes a sensing application of the smart home relying on a mobile network, and expands an application boundary of the mobile communication technology and the sensing technology.

In some embodiments of the present disclosure, the sensing event triggering request includes an identifier of the second UE, an identifier of the area authorized by the second UE to execute sensing, and an identifier of the sensing event.

In some embodiments of the present disclosure, the transceiving module 1710 is further configured to: receive a sensing report sent by the first network function, and the sensing report is configured to report to the second UE a result of the first UE executing the sensing event in the area authorized by the second UE.

In some embodiments of the present disclosure, the transceiving module 1710 is further configured to: send a sensing stop indication to the first network function and receive a sensing stop response from the first network function, and the sensing stop indication is configured to instruct the first network function to notify the first UE to stop executing the sensing event.

In summary, according to the apparatus for applying the device sensing capability provided in the present disclosure, the second UE may send the sensing event triggering request to the first network function, and receive the sensing event triggering response sent by the first network function to start an execution of the sensing event, that is, to notify the second UE that the first UE confirms to execute the sensing event, and may receive the sensing report to obtain an execution result of the sensing event. In addition, the second UE may send a sensing event stop request to stop the execution of the sensing event. The solution in the present disclosure provides the use case of the sensing technology based on the mobile communication technology in the smart home, realizes the sensing application of the smart home relying on the mobile network, and expands the application boundary of the mobile communication technology and the sensing technology.

FIG. 18 is a block diagram of an apparatus 1800 for applying device sensing according to an embodiment of the present disclosure. The apparatus 1800 for applying the device sensing may be used for a first network function. The apparatus 1800 includes a transceiving module 1810, and the transceiving module 1810 is configured to: receive a sensing event triggering request sent by a second user equipment (UE); send the sensing event triggering request to a first UE, in which the sensing event triggering request is configured to notify the first UE to execute a sensing event in an area authorized by the second UE; receive a sensing event triggering response sent by the first UE; and send the sensing event triggering response to the second UE, in which the sensing event triggering response is configured to notify the second UE that the first UE confirms to execute the sensing event.

In summary, according to the apparatus for applying the device sensing capability provided in the present disclosure, the SAF may perform an instruction interaction between the second UE (sensing requester) and the first UE (sensing executor), thereby instructing the first UE to execute the sensing event in response to the request of the second UE, providing a use case of a sensing technology based on a mobile communication technology in a smart home, realizing a sensing applications of the smart home relying on the mobile network, and expanding an application boundary of the mobile communication technology and the sensing technology.

In an embodiment of the present disclosure, based on the embodiment shown in FIG. 18, as shown in FIG. 19, the apparatus 1800 further includes: a configuring module 1820 configured to configure a sensing event execution parameter for the first UE, and the sensing event execution parameter includes at least one of a sensing location, a sensing range, a sensing time and a radio frequency.

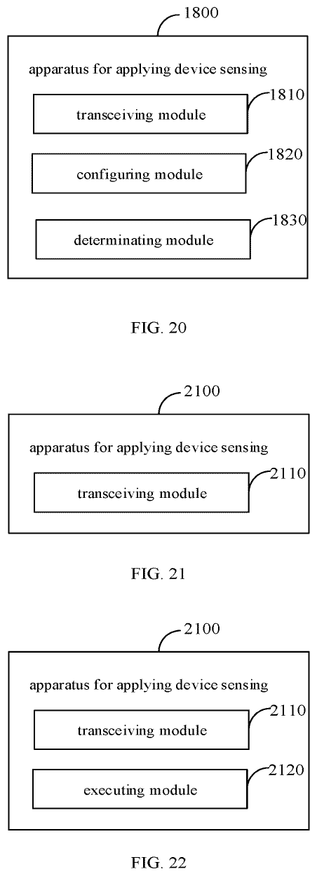

In some embodiments of the present disclosure, the sensing event triggering request includes an identifier of the second UE, an identifier of the area authorized by the second UE to execute sensing, and an identifier of the sensing event. Based on the embodiment shown in FIG. 18, as shown in FIG. 20, the apparatus 1800 further includes: a determining module 1830 configured to determine, based on the sensing event triggering request, whether the first UE is authorized to execute the sensing event in a range corresponding to the identifier of the area. The transceiving module 1810 is configured to send the sensing event triggering response to the second UE in a case that it is determined that the first UE is authorized to execute the sensing event in the range corresponding to the identifier of the area.

In some embodiments of the present disclosure, the transceiving module 1810 is configured to: receive a sensing report sent by the first UE; and send the sensing report to the second UE, in which the sensing report is configured to report to the second UE a result of the first UE executing the sensing event in the area authorized by the second UE.

In some embodiments of the present disclosure, the transceiving module 1810 is configured to: receive a sensing stop indication sent by the second UE; and send the sensing stop indication to the first UE, in which the sensing stop indication is configured to instruct the first UE to stop executing the sensing event.

In some embodiments of the present disclosure, the transceiving module 1810 is configured to: receive a sensing stop response sent by the first UE; and send the sensing stop response to the second UE.

In summary, according to the apparatus for applying the device sensing capability provided in the present disclosure, the SAF may perform an instruction interaction between the second UE (sensing requester) and the first UE (sensing executor), thereby instructing the first UE to execute the sensing event in response to the request of the second UE, and may receive the sensing report to obtain an execution result of the sensing event and forward it to the second UE. In addition, the SAF may receive and forward a sensing event stop request to stop the execution of the sensing event. The solution in the present disclosure provides a use case of a sensing technology based on a mobile communication technology in a smart home, realizes a sensing application of the smart home relying on a mobile network, and expands an application boundary of the mobile communication technology and the sensing technology.

FIG. 21 is a block diagram of an apparatus 2100 for applying device sensing according to an embodiment of the present disclosure. The apparatus 2100 for applying the device sensing may be used for a first UE. The apparatus 2100 includes a transceiving module 2110. The transceiving module 2110 is configured to: receive a sensing event triggering request sent by a first network function, in which the sensing event triggering request is configured to notify the first UE to execute a sensing event in an area authorized by a second UE; and send a sensing event triggering response to the first network function, in which the sensing event triggering response is configured to notify the first network function that the first UE confirms to execute the sensing event.

In summary, according to the apparatus for applying the device sensing capability provided in the present disclosure, the first UE may receive the sensing event triggering request sent by the first network function, and send the sensing event triggering response to the first network function, so as to implement an execution of the sensing event. The solution in the present disclosure provides a use case of a sensing technology based on a mobile communication technology in a smart home, realizes a sensing application of the smart home relying on the mobile network, and expands an application boundary of the mobile communication technology and the sensing technology.

In an embodiment of the present disclosure, the transceiving module 2100 is configured to: receive a sensing event execution parameter configured by the first network function, in which the sensing event execution parameter includes at least one of a sensing location, a sensing range, a sensing time and a radio frequency.

In an embodiment of the present disclosure, based on the embodiment shown in FIG. 21, as shown in FIG. 22, the apparatus 2100 further includes an executing module 2120 configured to, in response to the sensing event triggering request, execute the sensing event according to the sensing event execution parameter, and generate a sensing report. The transceiving module 2110 is further configured to: send the sensing report to the first network function, in which the sensing report is configured to report a result of the first UE executing the sensing event.

In an embodiment of the present disclosure, the executing module 2120 is further configured to: execute the sensing event by collecting and analyzing at least one of Doppler frequency shift data, amplitude change data, and phase change data of a communication signal sent by a network device.

In an embodiment of the present disclosure, the transceiving module 2110 is further configured to: receive a sensing stop indication sent by the first network function; and send a sensing stop response to the first network function. The sensing stop indication is configured to instruct the first network function to notify the first UE to stop executing the sensing event.

In summary, according to the apparatus for applying the device sensing capability provided in the present disclosure, the first UE (sensing executor) may, via the SAF, in response to the sensing request of the second UE (sensing requester), execute the sensing event and generate the sensing report, and report an execution result of the sensing event to the second UE via the SAF. In addition, the first UE may receive and respond to a sensing event stop request to stop the execution of the sensing event. The solution in the present disclosure provides the use case of the sensing technology based on the mobile communication technology in the smart home, realizes the sensing application of the smart home relying on the mobile network, and expands the application boundary of the mobile communication technology and the sensing technology.

An embodiment of the present disclosure also provides a communication system, which includes a first user equipment (UE) and a first network function. The first UE sends sensing registration information to the first network function, the sensing registration information includes a sensing capability identifier, and the sensing capability identifier is configured to identify that the first UE supports a sensing function. The first network function authenticates whether the first UE meets a registration requirement. The first network function sends a registration response message to the first UE in a case that the first UE meets the registration requirement, and the registration response message is configured to indicate that the first UE completes a sensing registration.

An embodiment of the present disclosure also provides a communication system, which includes a first user equipment (UE), a first network function and a second UE. The second UE sends a sensing event triggering request to the first network function, and the sensing event triggering request is configured to instruct the first network function to notify the first UE to execute a sensing event in an area authorized by the second UE. The first network function receives the sensing event triggering request and sends it to the first UE. The first UE sends a sensing event triggering response to the first network function, and the sensing event triggering response is configured to notify the second UE that the first UE confirms to execute the sensing event. The first network function receives the sensing event triggering response and sends it to the second UE.

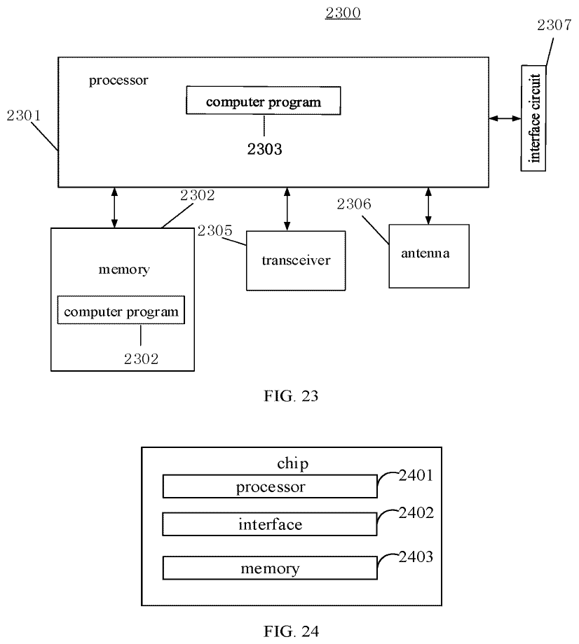

Referring to FIG. 23, FIG. 23 is a schematic diagram of a communication device 2300 according to an embodiment of the present disclosure. The communication device 2300 may be a network device; a user equipment; a chip, a chip system or a processor supporting the network device to implement the above methods; and a chip, a chip system or a processor supporting the user equipment to implement the above methods. The communication device may be configured to implement the methods as described in the method embodiments described above, with particular reference to the descriptions of the method embodiments described above.

The communication device 2300 may include one or more processors 2301. The processor 2301 may be a general-purpose processor or a special-purpose processor, etc. It may be, for example, a baseband processor or a central processor. The baseband processor may be configured to process a communication protocol and communication data, and the central processor may be configured to control a communication device (such as a base station, a baseband chip, a terminal device, a terminal device chip, a DU or a CU, etc.), execute a computer program and process data of the computer program.

In some embodiments, the communication device 2300 may further include one or more memories 2302 on which a computer program 2304 may be stored. The processor 2301 executes the computer program 2304 to cause the communication device 2300 to perform the methods as described in above method embodiments. In some embodiments, the memory 2302 may also have the data stored therein. The communication device 2300 and the memory 2302 may be arranged independently or integrated together.

In some embodiments, the communication device 2300 may further include a transceiver 2305 and an antenna 2306. The transceiver 2305 may be referred to as a transceiving unit, a transceiving machine, or a transceiving circuit or the like for implementing a transceiving function. The transceiver 2305 may include a receiver and a transmitter, and the receiver may be referred to as a receiving machine or a receiving circuit or the like for implementing a receiving function; the transmitter may be referred to as a transmitting machine or a transmission circuit or the like for implementing a transmitting function.

In some embodiments, the communication device 2300 may further include one or more interface circuits 2307. The interface circuit 2307 is configured to receive code instructions and transmit the code instructions to the processor 2301. The processor 2301 executes the code instructions to cause the communication device 2300 to perform the methods described in above method embodiments.

In an implementation, the processor 2301 may include a transceiver for implementing receiving and transmitting functions. For example, the transceiver may be a transceiving circuit, an interface, or an interface circuit. The transceiving circuit, the interface, or the interface circuit for implementing the receiving and transmitting functions may be separate or integrated together. The transceiving circuit, the interface or the interface circuit may be configured to read and write code/data, or may be configured to transmit or transfer signals.

In an implementation, the processor 2301 may store the computer program 2303 that, when running on the processor 2301, enables the communication device 2300 to perform the methods described in the above method embodiments. The computer program 2303 may be embedded in the processor 2301, in which case the processor 2301 may be implemented by hardware.

In an implementation, the communication device 2300 may include a circuit that may perform the transmitting, receiving or communicating function in the foregoing method embodiments. The processor and transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and transceiver may also be fabricated with various IC process technologies, such as complementary metal oxide semiconductors (CMOSs), negative channel metal-oxide-semiconductors (NMOSs), positive channel metal oxide semiconductors (PMOSs), bipolar junction transistors (BJTs), bipolar CMOSs (BiCMOSs), silicon germanium (SiGe), gallium arsenide (GaAs), etc.

The communication device described in the above embodiments may be a network device or a user equipment, but the scope of the communication device described in the present disclosure is not limited thereto. The structure of the communication device may not be limited by FIG. 22. The communication device may be a stand-alone device or may be part of a large device. For example, the communication device may be: (1) a stand-alone integrated circuit (IC), or a chip, or a chip system or subsystem; (2) a set of one or more ICs, in which, the set of ICs may also include a storage component for storing data and computer programs; (3) an ASIC, such as a modem; (4) a module that may be embedded in other devices; (5) a receiver, a terminal device, an intelligent terminal device, a cellular phone, a wireless device, a handheld device, a mobile unit, an in-vehicle device, a network device, a cloud device, an artificial intelligence device, etc.; (6) others.

In a case that the communication device may be a chip or a chip system, reference is made to a schematic diagram of a chip shown in FIG. 24. The chip shown in FIG. 24 includes a processor 2401 and an interface 2402. One or more processors 2401 may be provided, and a plurality of interfaces 2402 may be provided.

In some embodiments, the chip further includes a memory 2403 for storing necessary computer programs and data.

Those skilled in the art may also understand that various illustrative logical blocks and steps listed in embodiments of the present disclosure may be implemented by an electronic hardware, a computer software, or a combination thereof. Whether such functions are implemented by a hardware or a software depends on specific applications and design requirements of an overall system. For each specific application, those skilled in the art may use various methods to implement the function, but such an implementation should not be understood as extending beyond the protection scope of embodiments of the present disclosure.

The present disclosure further provides a readable storage medium having stored therein instructions that, when executed by a computer, cause functions of any one of the above method embodiments to be implemented.

The present disclosure further provides a computer program product that, when executed by a computer, causes functions of any one of the above method embodiments to be implemented.

All or some of the above embodiments may be implemented by a software, a hardware, a firmware or any combination thereof. When implemented using the software, all or some of the above embodiments may be implemented in a form of the computer program product. The computer program product includes one or more computer programs. When the computer program is loaded and executed on the computer, all or some of the processes or functions according to embodiments of the present disclosure will be generated. The computer may be a general-purpose computer, a special-purpose computer, a computer network, or other programmable devices. The computer program may be stored in a computer-readable storage medium, or transmitted from one computer-readable storage medium to another computer-readable storage medium. For example, the computer program may be transmitted from one website site, computer, server or data center to another website site, computer, server or data center in a wired manner (such as via a coaxial cable, an optical fiber, a digital subscriber line (DSL)) or a wireless manner (for example, in an infrared, wireless, or microwave manner, or the like). The computer-readable storage medium may be any available medium that can be accessed by the computer, or a data storage device such as a server or a data center integrated by one or more available media. The available medium may be a magnetic medium (for example, a floppy disk, a hard disk, or a magnetic tape), an optical medium (for example, a high-density digital video disc (DVD)), a semiconductor medium (for example, a solid state disk (SSD)), or the like.

Those ordinary skilled in the art may understand that the first, second, and other numeral numbers involved in the present disclosure are only for convenience of description, and are not intended to limit the scope of embodiments of the present disclosure, nor are they intended to represent a sequential order.

The term “at least one” used in the present disclosure may also be described as one or more, and the term “a plurality of” may cover two, three, four or more, which are not limited in the present disclosure. In embodiments of the present disclosure, for a certain kind of technical features, the technical features in this kind of technical features are distinguished by terms like “first”, “second”, “third”, “A”, “B”, “C” and “D”, etc., and these technical features described with the terms “first”, “second”, “third”, “A”, “B”, “C” and “D” have no order of precedence or size.

As used herein, the terms “machine readable medium” and “computer readable medium” refer to any computer program product, device, and/or apparatus (e.g., a magnetic disk, an optical disk, a memory, a programmable logic device (PLD)) for providing machine instructions and/or data to a programmable processor, including a machine readable medium that receives machine instructions as a machine readable signal. The term “machine readable signal” refers to any signal used to provide the machine instructions and/or data to the programmable processor.

The systems and technologies described herein may be implemented in a computing system (e.g., as a data server) including a background component, a computing system (e.g., an application server) including a middleware component, a computing system including a front-end component (e.g., a user computer having a graphical user interface or a web browser, through which the user may interact with embodiments of the systems and technologies described herein), or a computing system including any combination of such background component, middleware component, or front-end component). Components of the system may be connected to each other by digital data communication (such as a communication network) in any form or medium. Examples of the communication network include a local area network (LAN), a wide area network (WAN), and the Internet.

The computer system may include a client and a server. The client and the server are generally remote from each other and typically interact through the communication network. A client-server relationship is generated by computer programs operating on corresponding computers and having the client-server relationship with each other.

It may be understood that steps may be reordered, added or deleted using various forms of processes illustrated above. For example, each step described in the present disclosure may be executed in parallel, sequentially or in different orders, so long as a desired result of the technical solution disclosed in the present disclosure may be achieved, which is not limited here.

Furthermore, it may be understood that various embodiments of the present disclosure may be implemented alone or in combination with other embodiments, as the solution allows.

Those skilled in the art may appreciate that units and algorithm steps of each example described in conjunction with embodiments disclosed herein may be implemented with the electronic hardware, or the combination of the computer software and the electronic hardware. Whether such function is implemented in hardware or software depends on the specific application and design constraints of the technical solution. Those skilled in the art may implement the described function in varying ways for each particular application, but such implementation should not be considered to be beyond the scope of the present disclosure.

It will be clear to those skilled in the art that, for convenience and brevity of the description, specific working procedures of the above systems, devices and units may refer to corresponding procedures in the preceding method embodiments and will not be repeated here.

The above description is only for the specific embodiments of the present disclosure, but the scope of the present disclosure is not limited thereto. Any person skilled in the art may easily think of changes or substitutions within the technical scope of the present disclosure, which shall be covered by the protection scope of the present disclosure. Therefore, the protection scope of the present disclosure shall be in line with the attached claims.

1. A method for registering a device sensing capability, performed by a first user equipment (UE), comprising:
sending sensing registration information to a first network function, wherein the sensing registration information comprises a sensing capability identifier, and the sensing capability identifier identifies that the first UE supports a sensing function; and
receiving a registration response message sent by the first network function, wherein the registration response message indicates that the first UE completes a sensing registration.

2. The method according to claim 1, wherein before sending the sensing registration information to the first network function, the method further comprises:
sending a session establishment request to a second network function; and
receiving a session establishment acceptance message sent by the second network function.

3. The method according to claim 1, wherein the sensing registration information further comprises:
an identifier of the first UE and an identifier of an area where the first UE is located.

4. The method according to claim 2, wherein the first network function is a sensing application function (SAF), and the second network function is an access and mobility management function (AMF).

5. A method for registering a device sensing capability, performed by a first network function, comprising:
receiving sensing registration information sent by a first user equipment (UE), wherein the sensing registration information comprises a sensing capability identifier, and the sensing capability identifier identifies that the first UE supports a sensing function; and
sending a registration response message to the first UE, wherein the registration response message indicates that the first UE completes a sensing registration.

6. The method according to claim 5, wherein before sending the registration response message to the first UE, the method further comprises:
authenticating whether the first UE meets a registration requirement based on the sensing registration information.

7. The method according to claim 6, wherein the sensing registration information further comprises: an identifier of the first UE and an identifier of an area where the first UE is located.

8-31. (canceled)

32. A communication device, comprising:
a transceiver;
a memory storing computer-executable instructions; and
a processor,
wherein the processor is connected to the transceiver and the memory respectively, and when executing the computer-executable instructions on the memory, configured to control the transceiver to:
send sensing registration information to a first network function, wherein the sensing registration information comprises a sensing capability identifier, and the sensing capability identifier identifies that the first UE supports a sensing function; and
receive a registration response message sent by the first network function, wherein the registration response message indicates that the first UE completes a sensing registration.

33. A non-transitory computer storage medium storing computer-executable instructions that, after being executed by a processor, cause the method according to claim 1 to be implemented.

34. A communication device, comprising:
a transceiver;
a memory storing computer-executable instructions; and
a processor,
wherein the processor is connected to the transceiver and the memory respectively, and configured to control the transceiver to receive and transmit a wireless signal, and cause the method according to claim 5 to be implemented, by executing the computer-executable instructions on the memory.

35. A non-transitory computer storage medium storing computer-executable instructions that, after being executed by a processor, cause the method according to claim 5 to be implemented.

36. The method according to claim 2, wherein sending the sensing registration information to the first network function comprises:
sending the sensing registration information to the first network function in response to the session establishment acceptance message.

37. The method according to claim 1, wherein the sensing capability indicates that the first U E supports smart home sensing, and the smart home sensing comprises an intrusion detection.

38. The method according to claim 2, wherein the session establishment request is a packet data unit (PDU) session process establishment request.

39. The method according to claim 7, wherein authenticating whether the first UE meets the registration requirement comprises:
determining, according to a pre-stored corresponding relationship table, whether the identifier of the first UE has a corresponding relationship with the identifier of the area where the first UE is located, wherein the pre-stored corresponding relationship table comprises a corresponding relationship between a UE identifier and an identifier of an area authorized for UE sensing; and
determining that the first UE meets the registration requirement in a case that the identifier of the first UE has the corresponding relationship with the identifier of the area where the first UE is located.

40. The method according to claim 6, wherein sending the registration response message to the first UE comprises:
sending the registration response message to the first UE in a case that the first UE meets the registration requirement.

41. The method according to claim 5, wherein the sensing capability indicates that the first UE supports smart home sensing, and the smart home sensing comprises an intrusion detection.

42. The communication device according to claim 32, wherein before sending the sensing registration information to the first network function, the processor is further configured to control the transceiver to:
send a session establishment request to a second network function; and
receive a session establishment acceptance message sent by the second network function.

43. The communication device according to claim 32, wherein the sensing registration information further comprises:
an identifier of the first UE and an identifier of an area where the first UE is located.

44. The communication device according to claim 42, wherein the processor is further configured to control the transceiver to:
send the sensing registration information to the first network function in response to the session establishment acceptance message.
